(19) United States
(12) Patent Application Publication
(10) Pub. No.: US 2007/0134467 A1
(43) Pub. Date: Jun. 14, 2007

(54) Three dimensional tomographic fabric assembly

(76) Inventor: Ian Sayers, Ribchester nr. Preston (GB)

Correspondence Address: VOITH FABRICS, 3040 BLACK CREEK ROAD, P.O. BOX 1411, WILSON, NC, 27893, US

(21) Appl. No.: 10/577,794

(22) PCT Filed: Oct. 29, 2004
(86) PCT No.: PCT/EP04/52731

§ 371 Date: Apr. 28, 2006

(30) Foreign Application Priority Data
Oct. 31, 2003 (GB) 0325463.8

(51) Int. Cl. B32B 37/00; B32B 3/04

(52) U.S. Cl. 428/121; 156/253

(57) ABSTRACT

The invention provides a method comprising the steps of laminating a series of layers of film material and cutting perforations in the films of the laminate to provide a foraminous fabric. Further the method comprise seamed or unseamed industrial fabrics made according to the method.

This invention relates to three dimensional tomographic fabric assemblies, in the nature of nonwoven fabrics and has particular, though not exclusive, relevance to nonwoven papermachine fabrics such as forming fabrics, press felts, dryer fabrics, though-air dryer (TAD) fabrics, hydroentanglement screens and transfer fabrics for use in a papermachine. The fabrics of the invention also have application as transfer/conveyor fabrics in machines other than papermachines and may be used, for example, as conveying fabrics, or as screens for latex impregnation of conventionally air-aid materials, for support or formation screens used in melt blowing or spun-bonded nonwoven fabrics.

Paper is conventionally manufactured by conveying a paper furnish, usually consisting of an initial slurry of cellulosic fibres, on a forming fabric or between two forming fabrics in a forming section, the nascent sheet then being passed through a pressing section and ultimately through a drying section of a papermaking machine. In the case of standard tissue paper machines, the paper web is transferred from the press fabric to a Yankee dryer cylinder and then creped, or alternatively on more modern machines a monofilament woven mesh dryer fabric conveys the web from the forming fabric to a through-air dryer, followed by a Yankee cylinder.

Papermachine clothing is essentially employed to carry the paper web through these various stages of the papermaking machine and to facilitate water removal from the sheet in a controlled manner. In the forming section the fibrous furnish is wet-laid onto a moving forming wire and water is encouraged to drain from it by means of suction boxes and foils. The paper web is then transferred to a press fabric that conveys it through the pressing section, where it usually passes through a series of pressure nips formed by rotating cylindrical press rolls. Water is squeezed from the paper web and into the press fabric as the web and fabric pass through the nip together. In the final stage, the paper web is transferred either to a Yankee dryer, in the case of tissue paper manufacture, or to a set of dryer cylinders upon which, aided by the clamping action of the dryer fabric, the majority of the remaining water is evaporated.

Papermachine fabrics traditionally consist of a woven fabric. As the warp and weft yarns interweave, a so-called “knuckle” is formed as they cross. These knuckles have a tendency to mark the paper sheet formed on the fabric. This problem is particularly apparent at the wet end of the papermachine where the sheet is still highly plastic. In recent years, various methods have been suggested for making nonwoven papermachine fabrics in order to eradicate the problem associated with knuckle marking, particularly for press and dryer section applications. Many of these have been impractical to manufacture commercially.

GB 1,053,954 describes a nonwoven papermakers fabric comprising two layers of parallel polymeric filaments, the layers being attached together in such a manner that the filaments of one layer are disposed at an angle with respect to the filaments in another layer. Such an arrangement is not durable and consequently this fabric is not commercially viable.

U.S. Pat. No. 3,617,442 describes a forming fabric comprising a sheet of synthetic, open-celled, flexible foam such as polyurethane. This is reinforced by a series of polyester cables, a coarse wire screen or a thin flexible metal or plastic sheet. Such an arrangement, if ever commercialised, would exhibit poor wear resistance.

GB 2,051,154 relates to a so-called “link belt” in which a base fabric is formed from a series of interdigitated helices joined together by pintle wires. Link belts are only suitable for certain applications, due to calliper and material restrictions.

U.S. Pat. No. 4,541,895 describes a papermakers fabric made up of a plurality of nonwoven sheets laminated together to define a fabric or belt. The nonwoven sheets are perforated by laser drilling. Such sheets are composed of unoriented polymer material, and if produced in the fineness needed for papermaking applications, would lack sufficient dimensional stability to operate as endless belts on papermachines.

The subject invention of GB 2,235,705 describes a base fabric for press felts. Here an array of sheath-core yarns of which the core has a higher melting point than the sheath, is fed in spaced parallel disposition to peripheral grooves of a press roller arranged in nip-forming relationship with a press roll. The material of the sheath is melted as the yarns move into and through the roller nip and excess melted sheath material is forced into lateral and vacant circumferential grooves in the roller to form structural members between adjacent yarns. A wide belt may be formed by joining similar strips together. A batt of fibres is subsequently needled to the base fabric so as to form a press felt. The base fabric provided in accordance with GB 2,235,705 has large land areas. Thus there is a lot of “dead” space which can result in the production of an uneven paper sheet.

GB 2,241,915 relates to a method of producing a papermaking fabric in which a layer of photopolymeric resin is applied to a moving band. A moving, selectively transparent, mask is positioned above the resin and the resin is irradiated through the mask to effect an at least partial cure of the parts of the resin layer in register with the transparent regions of the mask. After irradiation uncured regions of the resin are removed by pressure fluid jets and final curing of the resin is effected either thermally or by means of flooding actinic radiation. The foraminous sheet so formed may be reinforced with yarns or fibres.

GB 2,283,991 relates to papermachine clothing made from partially fused particles. A reinforcing structure is embedded within the structure. This papermachine clothing is suitable for pressing applications and possibly special forming applications.

U.S. Pat. No. 3,323,226 relates to a synthetic dryer belt comprising one or more plies of polyester film. Perforations through the belt are formed by mechanical punching.

U.S. Pat. No. 4,541,895 relates to a papermakers fabric comprising a plurality of nonwoven sheets laminated together. The patent has particular application in relation to forming fabrics and press felts. For certain applications it is considered desirable to produce the drainage apertures or holes after the various layers have been laminated together. For other applications, it is desirable to produce apertures of varying sizes in the individual layers and then laminate those perforated layers together. This latter method has not been realised for a number of reasons. The thin layers are difficult to handle, in practice, and laser welding causes damage to the layers. It is also impossible to correctly align the various layers so as to provide uniform porosity. This requirement is essential for modern papermachine clothing.

U.S. Pat. No. 5,730,817 describes a method of making a product by laminated object manufacture (LOM).

The products made in accordance with U.S. Pat. No. 5,730,817 by LOM have generally been one-off prototypes which are rigid and have no function other than to aid the manufacture of an end product of similar dimensions, but which is made from a different material, for example metal.

The use of laminated object manufacture in the manufacture of papermachine clothing and other industrial fabrics has not previously been contemplated in that the potential of applying that technology to flat, wide, long flexible structures has not hitherto been considered.

According to a first aspect of the present invention there is provided a method of making a fabric by laminated object manufacture.

According to a second aspect of the present invention there is provided a fabric made by laminated object manufacture.

According to a third aspect of the present invention there is provided a method of making a fabric by laminating a series of layers of film material and cutting perforations in the films of the laminate to provide a foraminous fabric, the method involving the step of cutting perforations in at least one of said film layers after the film layer is secured to another film layer or film layers, one of said another layer or layers having pre-cut perforations therein.

According to a further aspect of the present invention there is provided a fabric made in accordance with the third aspect of the invention.

According to a further aspect of the present invention there is provided a seamed fabric comprising a laminate of foraminous films, wherein seam loops are defined by film material.

The seam loops may be provided by folding a fabric structure to provide a double thickness fabric having seam loops or by encircling film material around a fabric inner so as to define loops between said encircling film and said inner.

The method of the invention provides for accurate alignment of holes in the individual layers of the fabric so as to ensure that the fabric as a whole is foraminous, i.e. has perforations therethrough. The lay-down of a blank film need not be particularly precise if the holes in it are to be cut as a subsequent process. This is because of the ability of a sophisticated laser cutter to cut to a precise given depth.

The method of the invention provides for rapid fabric manufacture.

The method of the invention may be used to create complicated fabric structures, with filaments having end sections which cannot be utilised in conventional weaving. For example, it is possible to cut lands at different widths to build up non-round end sections in the completed fabric. Thus the fabric may comprise lands, filaments or strands which are, for example, triangular in cross-section. Yams with such end sections would be liable to twisting or distortion during insertion into a woven fabric on a loom.

The process of the invention is ideally suited to the manufacture of papermachine dryer fabrics which generally have holes in the paperside in the order of 0.5 mm to 3 mm in length.

During LOM the laser cutter circumscribes the cut-out waste portions called ‘chads’ to make the holes. These chads are later removed by some means. This might include directing a burst of air at the waste material via a high pressure air jet or by using an air knife. Alternatively or additionally a vacuum may be used.

The depth to which the film material is cut increases with higher laser power. This can be adjusted to match the thickness of one or more individual laid down films. To achieve a uniform cutting depth, whilst an optics head accelerates and decelerates, the laser power is varied in proportion to the speed of the head.

The method facilitates the manufacture of a wide variety of fabric configurations. A wide variety of foraminous fabrics may be made having any aperture size, shape and distribution. The aperture size, shape and/or distribution may be deliberately varied and possibly randomised, within desirable tolerances, throughout (or at least in the paper support surface thereof) the fabric although the porosity of the fabric should be kept as uniform as possible. By varying the size, shape and distribution of the apertures in the paper support surface of the fabric the undesirable periodicity associated with regular weave structures is avoided.

The profile of the apertures in the Z direction of the final fabric may be selected as desired, by appropriate selection of the hole configuration in the individual film layers. Preferably the orifices of the paperside apertures will be smaller than at the wearside. Thus apertures which are tapered in cross section or substantially tapered are preferred, to allow for ease of cleaning.

In practice, during manufacture, the chads in each layer will preferably be superimposed upon holes already existing in the agglomerated film layers beneath them. A preferred hole configuration is conical or substantially conical, i.e. the paperside opening is smaller than the wearside opening. In making such arrangements it is best to start with the largest holes in the first layer and then work up with subsequent layers possessing smaller holes. This will mean that the chad will always be suspended prior to removal above a hole.

Bridging parts of holes, during fabric manufacture, can be accomplished by simply relying on the modulus of the film itself. Providing any overhang is not too great the film should be self-supporting.

In some circumstances the last-applied film layer is laid down with a light applied pressure, for example, by a roller. The pressure should be enough to secure the latest-applied film layer to the film beneath it. This partial adhesion would allow any part of a chad which is stuck to the layer beneath it to be removed more easily. Once removal has been effected the remaining material would be bonded permanently to the already built-up laminate by passage through a nip created by two rollers, at high pressure loading.

The laser beam used to cut the layers may be directed by an optics system. This may comprise one or more lenses and/or mirrors. This is particularly useful for cutting out small areas. However, where larger areas are to be cut out an xy translator is preferred, i.e. the laser itself moves. This prevents geometrical distortions because the laser beam can be precisely positioned by means of a linear stage. Cutting efficiency is increased, for to advance the high inertia, heavy weight system more times than would be really necessary would increase the risk of building inaccuracies into the process.

The thickness of the various film layers being laminated together to produce the fabric may be the same or different. For example, the thickness of the layers towards the machine side; i.e. wearside, of the fabric may be thicker than the later-added top ones. This would achieve the objectives as set out below.
(a) The build up of thickness would be more rapid, and there would be less layers to bond, the bonded areas being the weaker part of the structure.
(b) A thicker layer could be deliberately placed somewhere in the middle of the Z axis (thickness) to accommodate machine direction strengthening structures, such as yarns. The thickness of the film could match the yarn diameter to preclude the existence of bulges in the structure.
(c) Thinner film layers could then only be required where the hole geometry is changed, i.e. reduced or expanded. The thinner the individual film layer the less “stair stepping” will occur at the apertures through the foraminous fabric. Stair stepping may result in undesirable dirt retention.

It is possible to arrest manufacture of the fabric at a part-way stage, particularly if the laminate is in roll form. For example a fabric of the Invention might be manufactured economically by manufacturing the base or wearside of the fabric in a different manner to the opposite face of the fabric, the structure of which is more critical, particularly in papermaking applications. Here relatively thick layers of film are used at the fabric wearside. These may be bonded together and possibly holes of the same diameter may be used in these various layers such that the holes in the various layers may be cut together at the same time so as to save cutting time. Thus a semi-complete work piece is provided with holes cut in it.

A further blank film layer is then preferably bonded to this semi-complete work piece, and this material may be stored in roll form for future further processing by cutting the blank film layer and the addition of a further set of individually cut laminae which would form the opposite face of the fabric to the wearside.

When such semi-complete structures are manufactured, particularly when the upper face layer remains blank, it is desirable to include a reference point in the fabric structure for precise location of the laser beam with respect to the work piece. This might comprise a “lug” or the like cut out in one or more of the first laid down layers of the fabric. The lug would need to be external to the fabric being constructed, but attached to it. One technique for achieving this is described hereinafter.

On further processing, holes could be cut in any remaining blank film layer. Subsequent blank films could, in turn, then be adhered, pressed and bonded to this semi-completed structure. These subsequent films could, generally speaking, be thinner than the previously laid down films. These later laid down layers could be used to provide hole size reduction and/or hole direction change. In these later laid down layers the holes could be cut in the layers individually.

The industrial fabrics, such as dryer fabrics, made in accordance with the invention may be quite wide, for example 10 metres in width.

One possible way of manufacturing such a wide fabric, using an apparatus which is not as wide as the desired fabric width, would involve spiral winding the first formed laminate over rollers and bonding the laminated fabric to a return of the spiral. Alternatively film layers may be located side by side and the film layers of the subsequent layer may straddle the joints between the films in the first layer.

In one embodiment of the method of the invention a film layer is bonded to the previous layer by passing the two components through a bonding nip, adhesive having been applied to the underside of the most recent layer to be laid down. The laser perforation could take place immediately after the bonding and the resultant porous laminate as an open ended sheet could then be temporarily wound up until the time comes to add the next impervious layer. The advantages of this method of manufacture would be a smaller machine footprint and the ability to leave the ends of the composite free of adhesive ready for loop creation.

The film material preferably comprises any of the following materials either alone or in combination: polyester, polyimide or PEN (polyethylenenaphalate). Preferred examples are high performance films, such as those sold under the trade marks MYLAR (trade mark of DuPont), KAPTON (trade mark of DuPont) or TEONEX (trade mark of DuPont). The individual film materials used for the individual layers of the fabric may be the same or different.

The film may comprise nonwoven sheets made from fibres, whether they be organic or inorganic. For example, the sheet may comprise Nomex fibres.

The adhesive material for bonding adjacent film layers preferably comprises any of the following materials either alone or in combination: epoxies, epoxy bismaleimides, silicone RTVs.

The fabrics of the invention ideally comprise an array of yarns extending in the intended running direction thereof on a machine. Consequently drawn yarns, to prevent extension, are preferably added to the built up fabric. These yarns provide strength in the machine direction. The yarns are preferably monofilaments or multifilaments and are ideally made from any of the following materials: steel, polyester, polyamide, polyolefin, PPS, PEEK para-aramid or from inorganic material, for example glass or basalt. The yarns are preferably at least partly, and ideally, fully, encapsulated in the machine direction lands of the nonwoven fabric.

In a preferred embodiment of the invention drawn yarns could be incorporated into the fabric structure, after having initially laid down a number of layers. At the position in the Z direction where the drawn yarns are to be included the next film layer might be laid down as strips orientated in the running direction with small gaps between them to accommodate the drawn yarns. Ideally the film thickness will correspond to the yarn diameter so that when the next blank film is laid down, during fabric manufacture, on the strips and yarns there are no periodic bulges in evidence. Alternatively, the next blank film layer laid down could be processed whereby the laser could not only cut the holes in it, but could also cut narrow parallel lines to allow the thin strip of film between the lines to be subsequently removed. Film strips could be left with grooves alongside to accept yarn. The remainder of the void, not filled by the yarn, should be filled with a polymer to secure the yarn to the structure. An adhesive paste could, for example, be applied by means of a blade lying transverse to the direction of the grooves.

It is noted that the nearer the load bearing portion of a fabric is to the paperside of the fabric for papermakers fabrics, or simply the opposite side to the wearside on industrial fabrics, the less the sheet extension. Accordingly the method of manufacture of the invention facilitates the deliberate placement of the load bearing yarn to minimise sheet creping, which can, if severe enough, result in web folding or tearing in the dryer section. A discussion of the relevance of the “neutral line” of fabrics is found in EP 0,577,572. The technology of the invention facilitates the incorporation of strength-providing yarns close to the paperside surface such that the vector of forces resides close to that surface.

In order that the present invention may be more readily understood specific embodiments thereof will now be described by way of illustration only with reference to the accompanying drawings in which:

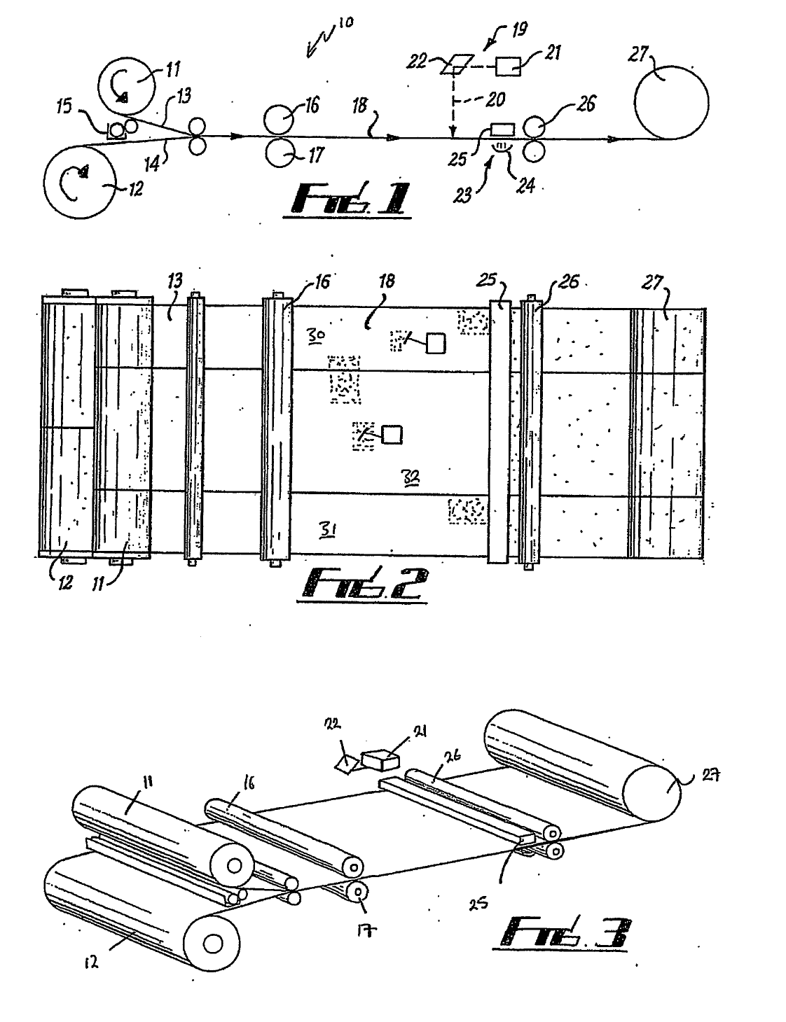

FIG. 1 is a simple diagrammatic illustration of one form of apparatus for use in manufacturing fabric in accordance with the present invention;

FIG. 2 is a plan view of the apparatus of FIG. 1;

FIG. 3 is an isometric drawing of the application of FIGS. 1 and 2;

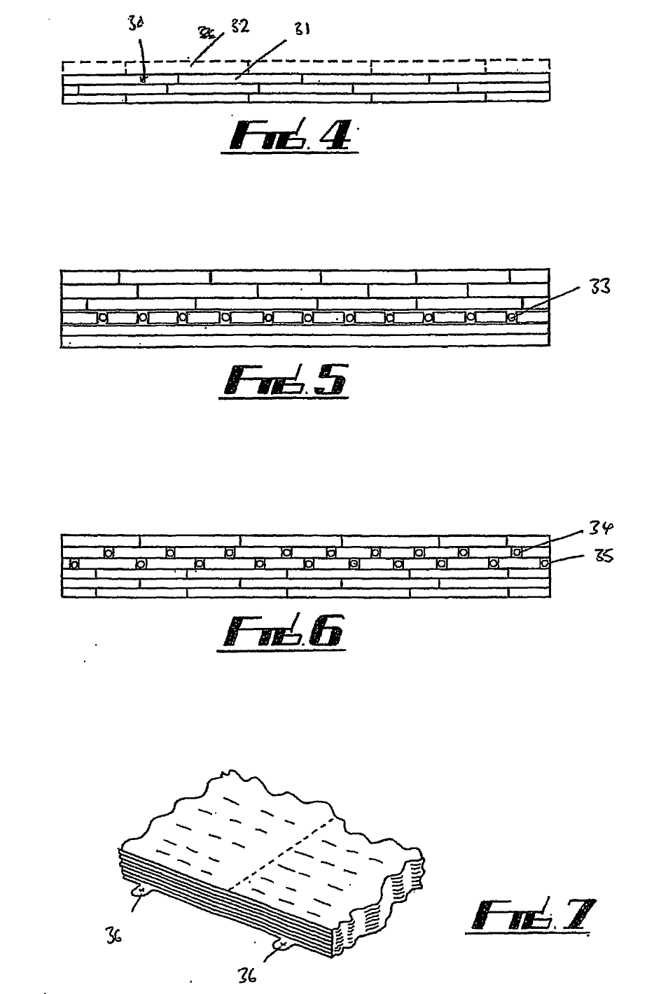

FIG. 4 shows the construction of part of a fabric in accordance with the present invention;

FIG. 5 shows the construction of a complete fabric in accordance with the present invention;

FIG. 6 shows the construction of a further fabric in accordance with the present invention;

FIG. 7 is a perspective view of part of a fabric made in accordance with the method of the present invention;

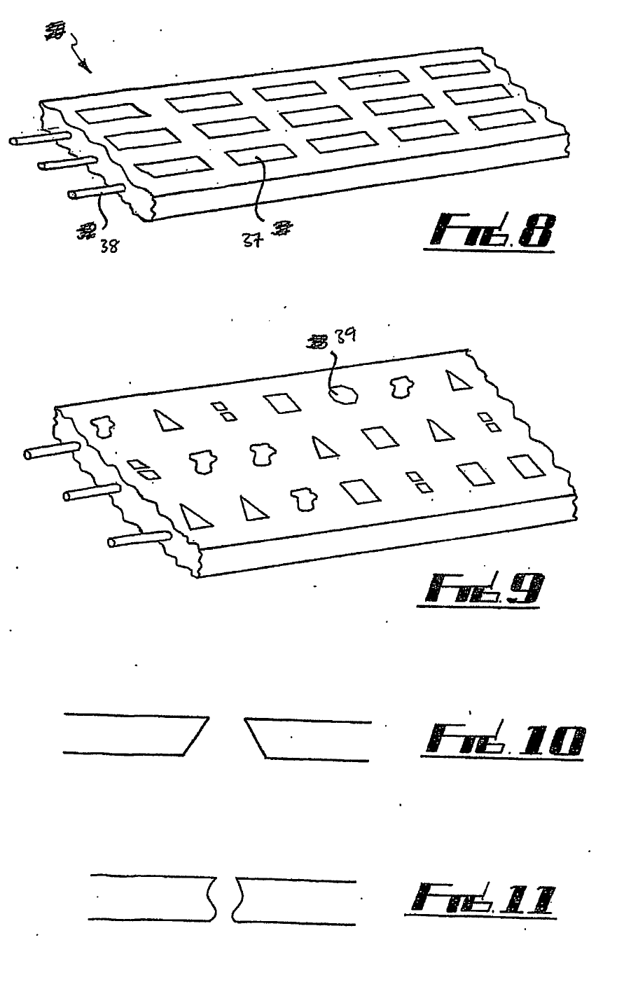

FIG. 8 is a perspective view of part of another fabric made using the method of the invention;

FIG. 9 is a perspective view of a further fabric made using the method of the invention;

FIG. 10 is a cross section through part of one fabric in accordance with the present invention;

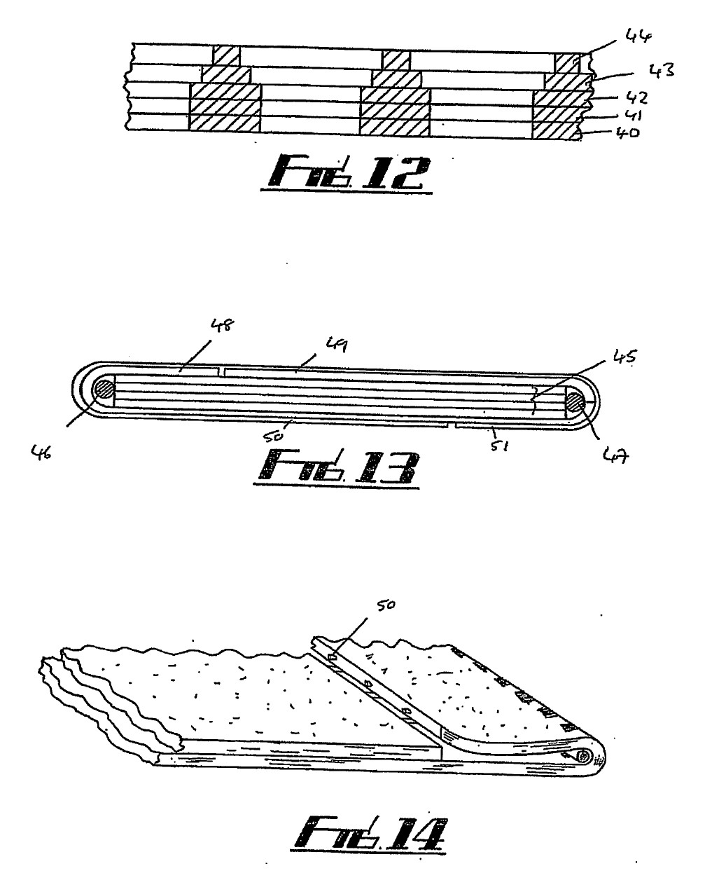

FIG. 11 is a cross section through a part of a second fabric in accordance with the present invention;

FIG. 12 shows the construction of a further fabric made in accordance with the method of the present invention;

FIG. 13 shows the construction of a fabric in accordance with the present invention having a seam; and

FIG. 14 shows the construction of a further seamed fabric in accordance with the present invention.

Referring to FIGS. 1 to 3 an apparatus 10 for making an industrial fabric, such as a papermakers dryer fabric, by way of laminated object manufacture comprises two feed rolls 11, 12. The apparatus, as illustrated in FIG. 1, is being used to bond an uncut plastics film 13 to a perforated laminate of such films 14 constructed on a previous run on the same or similar machine. In this example a papermakers dryer fabric is being manufactured and the film and adhesive have been selected to withstand the hot conditions within the dryer section of a papermachine. Consequently the plastics film comprises MYLAR (trade mark of DuPont), a polyester plastics film pre-coated with adhesive.

The roll of laminate is unrolled clockwise and the roll of uncut material is unrolled in an anticlockwise direction. An adhesive roller applicator 15 applies adhesive to the underside of the blank uncut film 13. The two films 13, 14 are fed between the nip formed between two pressure rolls 16, 17.

The plastics laminate 18 is fed to a cutting station indicated generally at 19. Cutting is achieved via laser beams 20 derived, respectively, from a multiplicity of 25 or 50 watt carbon dioxide lasers 21, only two of which are illustrated. Typically ten or more lasers would be used. The laser beams are delivered via x-y scanner systems which contain the final focussing optics 22. Movement of the laser generator 21 and optics 22 is controlled by computer software. The depth of cutting is controlled by altering the power of the laser, which again is powered by computer software. The perforations cut in the upper uncut film layer is in register, or partial register, with perforations already cut in the lower laminae as fed from roll 12. By cutting in partial register vertical holes can be cut with unusual Z direction profiles, for example an hour glass profile which could be set slightly sideways to provide a baffling effect. There would be a connection with a hole underneath, but register would not be absolute.

Waste cut material is removed by feeding the cut laminate through a waste removal station 23, which comprises an air blower 24 on one side of the laminate 18 and a suction box 25 on the other. The waste material, comprising a number of chads, is removed from the cutting area by a blast of high pressure air, from an air gun. The laminate 18 is then fed between a nip formed by the consolidation rolls and onto a storage roll. The consolidation rolls effectively firm up the bonding between the newly cut top layer and the preceding layer. Nip rollers 16, 17 cause the top layer to stick to the lower layer just enough so that there is no slippage. The light bondage would be an aid to chad removal if a portion of it actually lies above a land area of its predecessor. This would occur if the hole in the Z direction is deliberately constructed so that it lies at an angle to the plane of the fabric.

In use the dimensions of the fabric or section of fabric being manufactured are fed into the computer using a CAD-derived STL programme, such as LOMSLICE. This software effectively slices up the image of the fabrics into a multiplicity of layers, each of a thickness equating to the thickness of film, taking account of the adhesive secured thereto.

Under the control of the computer programme, thin layers of adhesive coated film are sequentially bonded to each other and individually cut by the laser beams. Thus the coated plastic film is fed from the feed roll to the cutting station where a section of the material is cut so as to resemble a first layer of the fabric being manufactured. After cutting, this first layer is freed from the remaining film sheet. The laser beam power is selected so as to cut a film depth equal to the thickness of a single layer of film. This degree of precision cutting, where the layer beneath the layer to be perforated is hardly scored at all, is realisable and is referred to as “kiss cutting”. It is noted that the lasers may not be undertaking the same task in each panel. The laser heads should therefore be de-coupled from one another to allow them to have independency of movement. The lasers may work in different zones of their prescribed field of activity. It is likely that the ablation process (hole boring) will generate heat in the film. The lasers may therefore be programmed to work on a selected area and then move off to allow localised heat, which has built up, to dissipate. Meanwhile the cutter can be operating elsewhere within its permitted area. Eventually, the discrete patterns will become joined together before a new blank film is advanced for the processing to be repeated.

As this additional film is advanced over the previously cut film heated roller is applied bonding the new blank film to the previously cut film. This melts the heat sensitive adhesive applied on the base of the blank film and bonds the film to the aforementioned cut first layer in order that the additional film layer may likewise be cut in accordance with the instructions provided by the computer programme. Alternatively, a thermal cure type of adhesive may be used, which is tacky in its virgin state and then cross-links under the influence of heat to bond both film layers together. Any waste material is removed by application of air from the air blower 24 and suction from the suction box 25. As a blank film is being bonded to lower layers, if there is a degree of shrinkage, due to the applied heat, this will occur before the film is perforated.

Further film may then be fed over the rectangular cut out section of the first film layer and bonded to this section by application of the pressure roller. Again under control of the computer the lasers cut out a series of chads in the second film layer. These chads align, or partially align, with the holes left in the rectangular cut out section of the first film layer. The chads are then removed by air pressure and the process is repeated until a block of fabric is manufactured comprising a laminate of superimposed rectangular cut out sections.

One or more layers of monofilament yarns may be located between two of the fabric layers during the manufacturing process. If so these would extend in zones which are not scheduled for cutting by the computer. Thus in the finished product these would protrude through the lands of the fabric inbetween the apertures. The yarns extend in the intended machine direction of the fabric to provide strength.

As a final point with regards to FIG. 2, in particular, it can be seen that the film layers are built up laterally in brickwork fashion. The position of the boundary of the two films 31, 32 on the bottom roll relative to the boundaries of the film 32 on the top roll, as shown in FIG. 2, clearly show overlapping. This results in the build up of film strips in an overlapping brickwork fashion. This can clearly be seen in a section through the final product, for example as shown in the partly constructed fabric of FIG. 4 and the fully constructed embodiments of FIGS. 5 and 6. The embodiments of FIGS. 5 and 6 show drawn yarns 33, 34, 35 extending in the intended running direction of the fabric belt. In FIGS. 5 and 6 it can be seen that the incorporation of the yarns does not cause bulges in the fabric. The drawn yarns may be provided in one layer as shown in FIG. 5 or in more than one layer as shown in FIG. 6. In FIG. 6 it is noted that the drawn yarns 34, 35 in different layers are not vertically stacked.

FIG. 7 shows part of a fabric made in accordance with the invention having lugs 36 cut into the first film layer. These lugs 36 act as position-finding reference points for subsequent operations. The apparatus consequently usefully employs image seeking optics and electronics to pick up the precise co-ordination of the lugs 36. There will usually be a lug associated with every panel to be cut. Thus on having cut the holes in the first layer, a lug is also cut so that the relativity is established between some precise point cut into the lug and the first line of holes in the film which has just been perforated. All the laser cutters will take their positioning from the lug. Therefore if the fabric wanders slightly as it is unrolled for the application of the next film layer, this deviation will be measured and the laser heads will position themselves accordingly. It is noted that, initially, the bottom film layer is, perforce, wider than the other film layers to allow for lug cutting. The remainder of the edge of the bottom layer is trimmed back to coincide with the edges of the other films in the laminate.

Fabrics made in accordance with the invention may have any desired configuration. The fabric illustrated in FIG. 8 has an array of regularly shaped apertures 37 which are rectangular in plan view. Monofilament yarns 38 extend through the fabric in the machine direction inbetween the holes.

In the fabric of FIG. 9 the configuration of holes 39 is not regular and is randomly generated by a computer, whilst maintaining substantially uniform porosity through the fabric.

The apertures through the fabric may be of any configuration although conical holes or the like are preferred. The cross section of two preferred hole arrangements is shown in FIGS. 10 and 11. Here the smaller orifice is provided at the paperside of the fabric rather than the wearside.

FIG. 12 shows how the shape of the apertures through the fabric may be achieved by removing various amounts of film material in adjacent film layers. In the illustrated embodiment the bottom three films 40, 41, 42; i.e. the films on the wearside have been laminated together and cut, the cutting of the three layers taking place in a single step. The next layer 43 is then constructed by adhering a blank film to the film comprising the first three laid down layers 40, 41, 42 and then removing slightly more film material centred around the existing apertures. A further similar step occurs in the next laminate 44 resulting in paperside orifices which are wider than the wearside orifices. The arrangement is illustrated in FIG. 12. This provides layers resembling stairs or steps; i.e. so-called “stair stepping”.

FIG. 13 shows how a flat laminate may be converted into a fabric belt with seamable ends. Here the inner body 45 of the fabric is made up of layers in like manner to the embodiments previously described. However, it is desirable to add seam loops at either end of the structure for interdigitation and connection via a pintle wire. The seam loops may be made by wrapping a film around the full length of the fabric and back on itself, the film being wrapped around dummy monofilaments 46, 47 provided at the ends of the inner fabric to define the gap for receiving the pintle wire. In the embodiment illustrated each full loop is made up of two films 48, 49, 50, 51 with abutting ends. These film loops are laid down blank and holes are cut into them via the lasers in like manner to that previously described. This ensures registration of the holes with the holes in the fabric inner. Ideally, and as illustrated, at least two full loops of film extend around the inner body. In FIG. 13 it can be seen that the abutments of the two parts of the first inner ring may not align with the abutments in the outer ring. This displacement of joints minimises any lack of uniformity.

Drawn yarns 50 may be incorporated into the body of the fabric assembly. Such an arrangement is shown in FIG. 14. With reference to FIG. 14 a fabric is made by making a film with only 50% of the final fabric thickness and roughly twice the desired length of the flat unseamed fabric. The fabric is then folded over at points set apart by a distance equating to the desired circumferential length of the seamed dryer fabric. When folded over the two ends would be destined to meet at the mid-point of the finished fabric. The top of the fabric construction, prior to folding is coated with adhesive and the fabric then folded over. As the fabric is already perforated, re-location via strategically placed pins, on a suitable bed, should not be difficult, although potential difficulties in aligning the precut perforations probably make this method slightly less desirable than that discussed with reference to FIG. 13. This method of manufacture is such that the seam ends of the fabric are produced at the same time obviating seam creation as a separate stage. It is a relatively straightforward operation to castellate the seam ends to provide loops for interdigitation.

It is noted that only one layer of drawn yarns is provided at the seam in the embodiment of FIG. 14. No such drawn yarns are provided in the embodiment of FIG. 13 and therefore a seam strengthening body is preferably incorporated. Generally speaking, if seam strength is an issue a seam, strengthening body is added at the seam zone. This might comprise a pre-preg comprising a woven fabric or an unidirectional array of yarns. Such unidirectional pre-pregs contain yarns, such as carbon or KEVLAR (Registered Trade Mark) yarns submerged in a highly viscous epoxy/phenolic pre-preg. This would be supported on a siliconized release paper. Alternatively a fine fabric may be used. One possibility is the use of an aramid woven cloth, such as KEVLAR®. This cloth would be adhered to the fabric structure at the seam and to part of the fabric zone incorporating the strength-providing yarns.

It is to be understood that the above described embodiments are by way of illustration only. Many modifications and variations are possible.

1. Method of making an industrial fabric comprising the use of laminated object manufacture.

2. The method of claim 1,
further comprising the steps of laminating a series of layers of film material and cutting perforations in the films of the laminate to provide a foraminous fabric.

3. The method of claim 2,
wherein a first layer of film material is bonded to a second layer of film material by application of pressure.

4. The method of claim 2,
further comprising the step of applying adhesive to an underside of the most recent layer of film material to be laid down.

5. The method of claim 2,
wherein the step of cutting perforations is performed using laser light.

6. The method of claim 2,
wherein at least one of the layers of film material has pre-cut perforations therein.

7. The method of claim 2,
wherein cut-out waste is removed by at least one of directing a burst of air at the waste material via a high pressure air jet, use of an air knife and sucking the waste by vacuum.

8. to the method of claim 7,
further comprising the step of permanently bonding the layers by applying pressure load after removal of said cut-out waste.

9. The method of claim 2,
wherein in the cut-out step at least one laid down film is perforated.

10. The method of claim 2,
wherein in the cut-out step at least two laid down films are perforated, further comprising the step of starting with the film having the largest holes in the first layer and then work up with subsequent film layers possessing smaller holes.

11. The method of claim 2,
wherein the perforations are cut-out in such a way that at least one of aperture size, shape and distribution varies in at least one of a predetermined manner and randomised throughout the fabric wherein the porosity of the fabric is kept substantially uniform.

12. The method of claim 2,
wherein the manufacture of the fabric is stopped at a semi-complete stage.

13. to the method of claim 12,
further comprising the step of bonding a blank film layer to the laminated structure generating a semi-complete work piece, and that said semi-complete work piece is stored in roll form for further processing by cutting the blank film layer and the addition of a further set of individually cut laminate which can form the opposite face of the fabric to the wearside.

14. to the method of claim 13,
wherein a reference point is included to said semi-complete work piece for precise location of the laser beam with respect to said work piece.

15. The method of claim 2,
further comprising the step of spiral winding a first formed laminate over rollers and bonding the laminated fabric to a return of the spiral.

16. The method of claim 2,
wherein the film layers are located side by side and the film layers of the subsequent layer may straddle the joints between the films in the first layer.

17. An industrial fabric manufactured with a method according to claim 1.

18. to the industrial fabric of claim 17,
wherein orifices of paperside apertures are smaller than at a wearside.

19. The industrial fabric of claim 17,
wherein thickness of the various film layers being laminated together are different.

20. Seamed industrial fabric comprising a laminate of foraminous films, wherein seam loops are defined by film material.

21. The seamed industrial fabric of claim 20,
said seam loops being provided by folding a fabric structure to provide a double thickness fabric having seam loops.

22. The seamed industrial fabric of claim 20,
said seam loops being provided by encircling film material around a fabric inner so as to define loops between said encircling film and said inner.

23. The industrial fabric of claim 17,
wherein said fabric is a paper machine clothing.

24. The industrial fabric of claim 17,
wherein said film material comprises at least one of the following materials: polyester, polyimide, PEN (polyethylenenaphalate), high performance films, MYLAR, KAPTON and TEONEX.

25. The industrial fabric of claim 17,
wherein the individual film materials used for the individual layers of the fabric may be one of the same and different.

26. The industrial fabric of claim 17,
wherein the film may comprise nonwoven sheets made from fibres.

27. The industrial fabric of claim 17,
wherein the adhesive material for bonding adjacent film layers comprise at least one of the following materials: epoxies, epoxy bismaleimides, and silicone RTV's.

28. The industrial fabric of claim 17,
wherein said fabric comprise an array of yarns extending in the intended running direction of said fabric.

29. The industrial fabric of claim 28,
wherein said yarns are at least one of monofilaments and multifilaments.

30. The industrial fabric of claim 28,
wherein said yarns are at least partly encapsulated in machine direction lands of said fabric.

31. The industrial fabric of claim 30,
whrein said yarns are incorporated into the fabric structure, after having initially laid down a number of layers.

32. The industrial fabric of claim 31,
wherein at a position in the Z direction where said yarns are to be included a next film layer have been laid down as strips orientated in the running direction with small gaps between them to accommodate the yarns.

33. The industrial fabric of claim 32,
wherein a film thickness corresponds to a yarn diameter.

34. The industrial fabric of claim 30,
wherein void not filled by the yarn is filled with a polymer to secure the yarn to the structure.

35. The method of claim 3,
wherein the application of pressure is by passing the two components through a bonding nip.

36. The industrial fabric of claim 19, wherein the thickness of the layers towards the intended machine side is thicker than the layers towards the intended paper side.

37. The industrial fabric of claim 17,
wherein the fabric is a seamed industrial fabric.

38. The industrial fabric of claim 29,
wherein the at least one of monofilaments and multifilaments are made from at least one of the following materials: steel, polyester, polyamide, polyolefin, PPS, PEEK para-aramid and inorganic material.

39. The industrial fabric of claim 38, the inorganic material is one of glass and basalt.
